(19) United States
(12) Patent Application Publication
(10) Pub. No.: US 2015/0143884 A1
(43) Pub. Date: May 28, 2015

(54) Method and Apparatus for Estimating a Dosing-Error in a Selective Catalytic Reduction System

(71) Applicant: Perkins Engines Company Limited, Cambridgeshire (GB)

(72) Inventors: David Heaton, Cambridgeshire (GB); Michail Soumelidis, Essex (GB); Bastian Maass, Geinsheim (DE); Thomas Steffen, Leicestershire (GB)

(73) Assignee: Perkins Engines Company Limited, Cambridgeshire (GB)

(21) Appl. No.: 14/403,090

(22) PCT Filed: Jun. 20, 2013
(86) PCT No.: PCT/GB2013/051628

§ 371 Date: Nov. 21, 2014

(30) Foreign Application Priority Data
Jun. 20, 2012 (GB) 1210924.5

(51) Int. Cl. F01N 3/20; G01M 15/10

(52) U.S. Cl. CPC F01N 3/2066; G01M 15/102
USPC 73/114.75

(57) ABSTRACT

A method for determining if a selective catalytic reduction (SCR) device that is dosed with a reductant is being mis-dosed by considering an expected exhaust gas output state from the SCR device and measured exhaust gas output state, a NOx sensor sensitivity figure that is an indication of how sensitive the measured exhaust gas output state is to dosing errors and performing cross-correlation operations.

This disclosure relates to a method and apparatus for estimating a dosing error in a selective catalytic reduction system.

### BACKGROUND

Selective catalytic reduction (SCR) systems may be used to convert nitrous oxides (NOx) which may be produced, for example, by an internal combustion engine, into less harmful emissions, such as nitrogen and water. The SCR system may comprise a catalyst which facilitates a reaction between the NOx, which may be present in a gas stream passing through the SCR system, and a reductant in order substantially to remove the NOx from the gas stream.

The reductant may be added to the gas stream and absorbed onto the catalyst before it reacts with the NOx in the gas stream passing through the SCR system. Where the reductant used is ammonia, it may be added to the gas stream as, for example, anhydrous ammonia, aqueous ammonia or urea which thermally decomposes into ammonia within the SCR system before being absorbed onto the catalyst.

When the SCR system is dosed with reductant correctly, the ammonia storage level on the catalyst may be maintained at an optimum level and the reaction between the ammonia and NOx may eliminate nearly all of the NOx and ammonia. If the SCR system is over dosed, there may be more ammonia within the SCR system than can be absorbed onto the catalyst, which may result in ammonia being emitted from the SCR system (commonly known as ‘ammonia slip’). Ammonia emissions may be undesirable as they can be very harmful to the environment. If the system is under-dosed, there may be insufficient ammonia absorbed onto the catalyst to react with all of the NOx passing through the SCR system, which may result in unprocessed NOx being emitted from the SCR system. This reduces the conversion efficiency of the SCR system and is therefore also undesirable.

It may, therefore, be desirable to control the level of dosing so that the ammonia storage level is maintained at an optimum level. However, the amount of ammonia stored is not directly measurable. Consequently, it may be necessary to estimate the storage state within the catalyst.

The storage state of the catalyst may depend upon a number of factors, which might include the temperature of the catalyst and the amount of NOx passing into the SCR system. These factors may be monitored using, for example, a downstream NOx sensor and an upstream NOx sensor, a mass flow sensor and a temperature sensor, the readings of which may be used to estimate the ammonia storage level within the catalyst. However, these sensors have a limited accuracy, and are subject to long term sensor drift, making it difficult accurately to determine the state of the gas stream over time. Furthermore, the dosing device itself may have limited accuracy, causing a discrepancy between the dosing level determined by the control system and the actual dosing level applied to the catalyst.

Consequently, even if the estimated storage state of the catalyst is initially accurate, over time the accuracy of the estimate, and therefore the accuracy of the urea dosing, may diminish due to inaccurate data readings. As a result of the conservation of mass (for ammonia and NOx), even small errors may increase over time, and the actual storage level may differ significantly from the estimated storage level.

These inaccuracies may lead to a discrepancy in the order of 10% or more between the ideal dosage which should be applied to the SCR system in order to achieve maximum conversion efficiency with minimal ammonia slip, and the actual level of dosing which is applied to the SCR system. This may result in NOx or ammonia slip emissions as a consequence of under-dosing or over-dosing.

US patent application 2010/0024389 describes a dosing control system for an SCR system wherein a catalyst ammonia storage model is used to estimate the current ammonia storage level within a catalyst and the theoretical ideal ammonia storage level. Dosing is then applied to the catalyst at a level which brings the estimated storage level towards the theoretical ideal storage level.

An analysis module estimates an expected NOx out value based upon the catalyst ammonia storage model and measurements of exhaust conditions, such as NOx in, exhaust temperature and exhaust flow rate. An error term is then found by determining the difference between the estimated NOx out and a NOx out value measured by a downstream NOx sensor. This difference signal is fed-back to the analysis module to improve dosing accuracy by modifying the catalyst ammonia storage model to correct the dosing error.

However, NOx sensors are cross sensitive to ammonia to a degree which may vary over time. Consequently, a high reading from the NOx out sensor may be caused either by untreated NOx, caused by under-dosing, or by ammonia slip, caused by over-dosing.

Thus, an elevated reading from the downstream NOx sensor might indicate either: too much NOx being output, or ammonia being output. Since the first of these scenarios requires an increase in dosing and the second requires a decrease in dosing, the dosing level of the SCR system may not be reliably improved.

One solution to address the issues relating to the cross sensitivity of NOx sensors with ammonia, is to use a downstream ammonia sensor in combination with a downstream NOx sensor. With such an arrangement it may be possible to compensate for the cross-sensitivity and determine if there is untreated NOx or ammonia slip being output from the SCR system and correct the dosing error accordingly.

However, in addition to not taking into consideration any of the other factors relating to dosage errors, such as sensor drift and variations in levels of ammonia which may be stored on the catalyst caused by catalyst temperature changes, ammonia sensors are also not as reliable as NOx sensors and such systems are therefore not very robust.

Furthermore, the additional sensor increases the system complexity and cost. Therefore, it may be undesirable to use ammonia sensors for controlling the dosing of an SCR system.

### SUMMARY

The disclosure provides: a method for determining if a selective catalytic reduction (SCR) device which is dosed with a reductant is being mis-dosed, the method comprising the steps of: determining a NOx readout difference figure from the difference between an estimated exhaust gas output state from the SCR device and a measured exhaust gas output state from the SCR device; and determining a mis-dosing indication figure which indicates if the SCR device is being under-dosed, correctly dosed or over-dosed by cross-correlating the NOx readout difference with a NOx sensor sensitivity figure, wherein the NOx sensor sensitivity figure is an indication of how sensitive the measured exhaust gas output state is to dosing errors.

The disclosure also provides: a method for determining if a selective catalytic reduction (SCR) device which is dosed with a reductant is being mis-dosed, the method comprising the steps of: determining a first cross-correlation figure by cross-correlating a measured exhaust gas output state with a NOx sensor sensitivity figure, wherein the NOx sensor sensitivity figure is an indication of how sensitive the measured exhaust gas output state is to dosing errors; determining a second cross-correlation figure by cross-correlating an estimated exhaust gas output state from the SCR device with the NOx sensor sensitivity figure; and determining a mis-dosing indication figure which indicates if the SCR device is being under-dosed, correctly dosed or over-dosed from the difference between the first cross-correlation figure and the second cross-correlation figure.

The disclosure also provides: a controller to determine if a selective catalytic reduction (SCR) device that is dosed with a reductant is being mis-dosed, the controller being configured to determine a NOx readout difference figure from the difference between an estimated exhaust gas output state from the SCR device and a measured exhaust gas output state from the SCR device; and determine a mis-dosing indication figure which indicates if the SCR device is being under-dosed, correctly dosed or over-dosed by cross-correlating the NOx readout difference with a NOx sensor sensitivity figure, wherein the NOx sensor sensitivity figure is an indication of how sensitive the measured exhaust gas output state is to dosing errors.

The disclosure also provides: a controller to determine if a selective catalytic reduction (SCR) device that is dosed with a reductant is being mis-dosed, the controller being configured to determine a first cross-correlation figure by cross-correlating a measured exhaust gas output state with a NOx sensor sensitivity figure, wherein the NOx sensor sensitivity figure is an indication of how sensitive the measured exhaust gas output state is to dosing errors; determine a second cross-correlation figure by cross-correlating an estimated exhaust gas output state from the SCR device with the NOx sensor sensitivity figure; and determine a mis-dosing indication figure which indicates if the SCR device is being under-dosed, correctly dosed or over-dosed from the difference between the first cross-correlation figure and the second cross-correlation figure.

### FIGURES

FIG. 1 shows a schematic drawing of an engine unit comprising an SCR device;

FIG. 2 shows a schematic drawing of a controller that may be used to control the dosing of the SCR device shown in FIG. 1;

FIG. 3 shows a graphical representation of the NOx output levels that may be estimated at a single point in time by the estimator unit within the controller shown in FIG. 1 using a catalyst model, an over-dosing model and an under-dosing model; and

FIG. 4 shows an example vehicle within which the engine unit shown in FIG. 1 may be used.

### DETAILED DESCRIPTION

An SCR device may be used for a variety of applications where a reduction in NOx levels in a gas stream is desired. Such applications may include, but are not exclusive to, boilers, gas turbines and internal combustion engines, for example diesel engines.

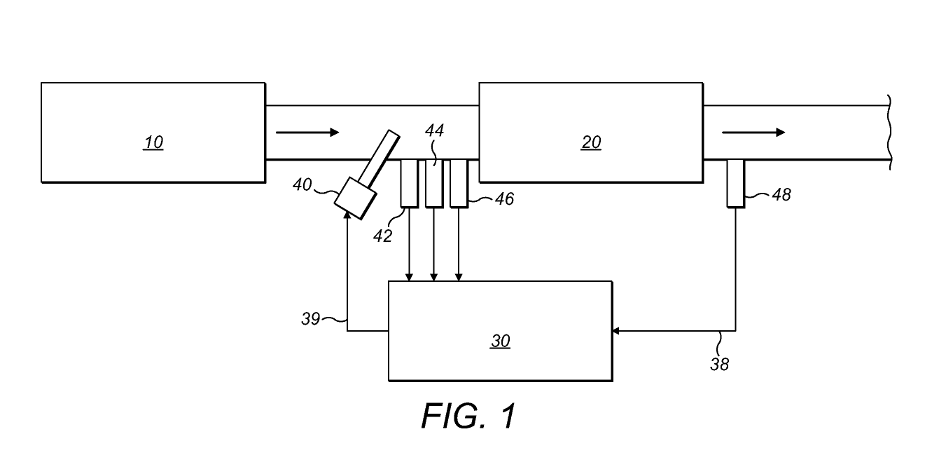

FIG. 1 shows an internal combustion engine 10 with an SCR device 20 at the exhaust of the internal combustion engine 10. The SCR device 20 in this arrangement may be dosed by injecting urea into the exhaust gas upstream of the SCR device 20 with an injector 40. However, any other suitable dosing agent, for example anhydrous or aqueous ammonia, may alternatively be used and added to the SCR device 20 using any suitable technique known to the skilled person, or ammonia may be created in a separate part of the system, such as an ammonia reactor.

A first (or upstream) NOx sensor 42, mass flow rate sensor 44 and temperature sensor 46 may be arranged to measure the state of the exhaust gas upstream of the SCR device 20. Additional or alternative sensors may be used to measure the state of the exhaust gas upstream of the SCR device 20. Alternatively, the state of the upstream exhaust gas may be estimated from measured engine parameters, for example engine speed, fuel injection quantity, altitude and ambient temperature.

The measured or estimated state of the exhaust gas upstream of the SCR device 20 may include at least one of NOx concentration, mass flow rate and temperature.

A second (or downstream) NOx sensor 48 may be arranged to measure the NOx concentration of the exhaust gas downstream of the SCR device 20. Additional sensors may also be provided downstream of the SCR device 20 in order to measure other aspects of the exhaust gas state. Different sensor positions for the downstream NOx sensor 48 are possible, for example within the SCR device 20 in a mid-brick position.

It may be desirable to control the level of urea dosing in order to maintain an optimum ammonia storage level for minimising NOx emissions and ammonia slip in the exhaust gas output from the SCR device 20. A controller 30 may be used to control the injector 40 to this end.

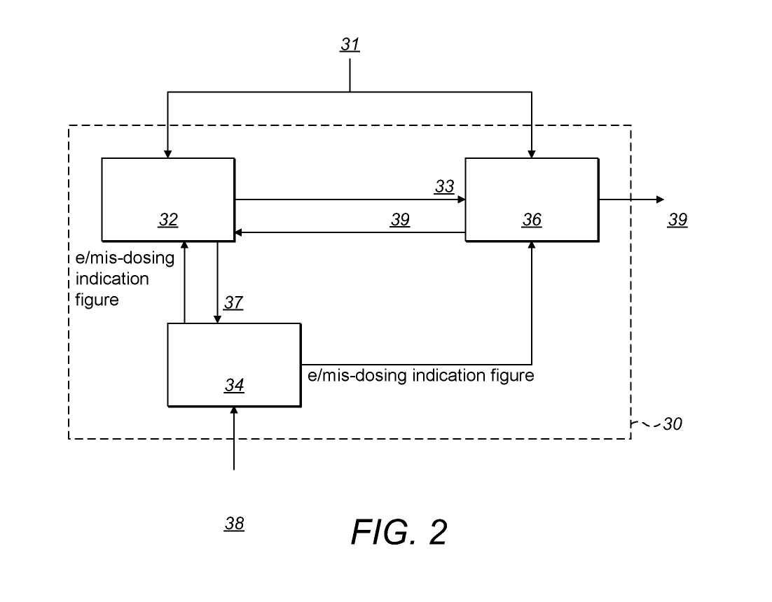

FIG. 2 shows details of the controller 30, which may include an estimator unit 32, an error calculation unit 34 and a dosing calculation unit 36.

Data relating to the exhaust gas state 31 of the exhaust gas flow into the SCR device 20 may be fed into the estimator unit 32 and the dosing calculation unit 36. In this example, the exhaust gas state 31 may include at least one of NOx concentration, mass flow rate and temperature, which may be read by the upstream NOx sensor 42, mass flow rate sensor 44 and temperature sensor 46. However, the exhaust gas state 31 may include different measurements of the exhaust gas input to the SCR device 20, or may instead be measured engine parameters, from which the estimator unit 32 may estimate an exhaust gas state.

In the example shown in FIGS. 1 and 2, the catalyst temperature may be estimated from the exhaust gas temperature upstream of the SCR device 20. However, the temperature may alternatively be obtained from a temperature sensor within the catalyst, or estimated from the downstream exhaust gas temperature, the upstream and downstream exhaust gas temperatures, or any other direct or indirect temperature measurement or estimation techniques which would be known to the skilled person.

Within the estimator unit 32, the exhaust gas state 31, the measured or estimated catalyst temperature and the current dosing level 39 may be fed into a catalyst model which may determine an estimate of the ammonia storage state 33 on the catalyst.

The dosing calculation unit 36 may use feed forward control to determine what level of dosing should be applied to the SCR device 20. This may be determined using a number of different techniques, and by considering a number of different measurement signals. For example, at least one of the current measured or estimated exhaust gas state 31, the catalyst temperature and the estimated ammonia storage state 33 may be considered in order to determine the dosing level.

The dosing calculation unit 36 may also perform feed forward control by determining the ideal or desired ammonia storage level of the catalyst for a given situation as determined by at least one of the measured or estimated exhaust gas state 31, the catalyst temperature, and the current or anticipated engine work load. This ideal or desired ammonia storage level may be the storage level at which NOx and ammonia slip output from the SCR device 20 is expected to be at a minimum. By determining the ideal or desired ammonia storage state, the dosing calculation unit 36 may compare it with the estimated ammonia storage state 33 and determine the dosing level required in order to bring the estimated ammonia storage state 33 closer to the ideal or desired ammonia storage state. Alternatively, an ideal or desired ammonia storage state may be input to the dosing calculation unit 36 from a different unit, either internal or external to the controller 30.

However, when using only feed forward control, the accuracy of the dosing level may not be very reliable, and factors such as sensor drift and changes in catalyst storage levels for a given temperature may cause the inaccuracies to increase over time.

The accuracy of the dosing level may be improved by determining whether mis-dosing is occurring, and if so what type of mis-dosing it is (i.e. over-dosing or under-dosing). Such a determination may then be used to perform feedback control of the dosing level.

In order to determine if mis-dosing is occurring, the estimator unit 32 generates the expected NOx output level 37, which may be determined using the catalyst model with, for example, at least one of the exhaust gas state 31, the catalyst temperature and the current dosing level 39.

The error calculation unit 34 in the controller 30 then finds the difference between the expected NOx output level 37 and a measured NOx output level 38 from the downstream NOx sensor 48. The result of this difference calculation shall be referred to herein as ‘the NOx readout difference’.

The NOx readout difference is then cross correlated with a NOx sensor sensitivity figure in order to determine whether under-dosing or over-dosing is taking place. The NOx sensor sensitivity figure indicates the sensitivity of the downstream NOx sensor 48 to reductant dosing errors.

To that end, the NOx sensor sensitivity figure may be an indication of how much the downstream NOx sensor reading is expected to change with the dosing error. The figure may be positive or negative, indicating a positive or negative sensitivity of the NOx out measurement to dosing errors, and may have a magnitude indicating the degree of sensitivity.

The NOx sensor sensitivity figure may be obtained using a number of different techniques, either before the control method is run, or during the running of the control method (run-time).

For example, the NOx sensor sensitivity figure might be estimated and set before running the control method, and that estimate be used throughout the running of the control method.

Alternatively, during run-time, a NOx sensor sensitivity figure might be determined using a model within the estimator unit which considers the measured NOx output level 38 as well as at least one of the catalyst temperature, the current dosing level 39 and the exhaust gas state 31 in order to generate the NOx sensor sensitivity figure. The model might also consider historical NOx output measurements.

A further run-time technique might be to differentiate the expected NOx output level 37 by a measure of the level of dosing error applied to the SCR device 20. The measure of the dosing error may be the dosing error figure e, the determination of which is explained later. When the dosing error figure e is used, the NOx sensor sensitivity figure may initially be calculated by assuming a notional dosing error of, for example, 0, which indicates that there is no dosing error. The NOx sensor sensitivity figure may then be gradually improved during run time when progressively more accurate figures for the dosing error figure e are determined. This differentiation may be performed in different ways, such as manual, computer aided or automatic differentiation, and may generate an accurate figure for the NOx sensor sensitivity, which may react to changes in the sensitivity of the downstream NOx sensor 48.

The NOx sensor sensitivity figure may also be obtained during run-time from the difference between the expected NOx out 37 obtained using the catalyst model and a NOx out estimate obtained using a modified catalyst model. In this instance, the estimator unit 32 may further comprise a model bank which comprises the catalyst model and the modified catalyst model, wherein each of the models may be run in parallel.

The modified catalyst model may be used to estimate the NOx output expected for an over-dosed or under-dosed SCR device 20 (i.e. a mis-dosing model). For example, the modified catalyst model may be used to obtain an estimate of NOx out for a 1% over-dosing condition, compared with the current dosing level 39. It should be noted, however, that rather than 1% overdosing, the modified catalyst model may alternatively use a different over-dosing or under-dosing percentage, for example 5% under-dosing.

The NOx sensor sensitivity figure may then be obtained by dividing the NOx readout difference by the difference between the expected NOx out 37 obtained using the catalyst model and the NOx out estimate obtained using the modified catalyst model.

Alternatively, the NOx sensor sensitivity figure may be obtained from the difference between a NOx out estimate obtained using an over-dosing catalyst model and a NOx out estimate obtained using an under-dosing catalyst model. In this instance, the estimator unit 32 may include a model bank that comprises the catalyst model, the over-dosing model and the under-dosing model, wherein each of the models may be run in parallel.

The under-dosing model may, for example, be used to estimate the NOx out expected for any notional under-dosing amount, such as a 1% under-dosing condition compared with the current dosing level 39, and the over-dosing model may, for example, be used to estimate the NOx out expected for any notional over-dosing amount, such as a 1% over-dosing condition compared with the current dosing level 39.

It should be noted, however, that the over-dosing and under-dosing models do not have to use equal and opposite mis-dosing percentages with respect to the current dosing level 39 and may, for example, use 3% under-dosing and 5% over-dosing.

The NOx sensor sensitivity figure may then be obtained by dividing the NOx readout difference by the difference between the expected NOx out obtained using the over-dosing model and the NOx out estimate obtained using the under-dosing model.

It should be noted that good results may also be obtained when the two mis-dosing models (i.e., the over-dosing and the under-dosing models) both estimate NOx output levels for different levels of over-dosing, or both estimate NOx output levels for different levels of under-dosing. For example, one model might use 3% over-dosing and the other model use 5% over-dosing, or alternatively one model might use 1% under-dosing and the other model use 2% under-dosing.

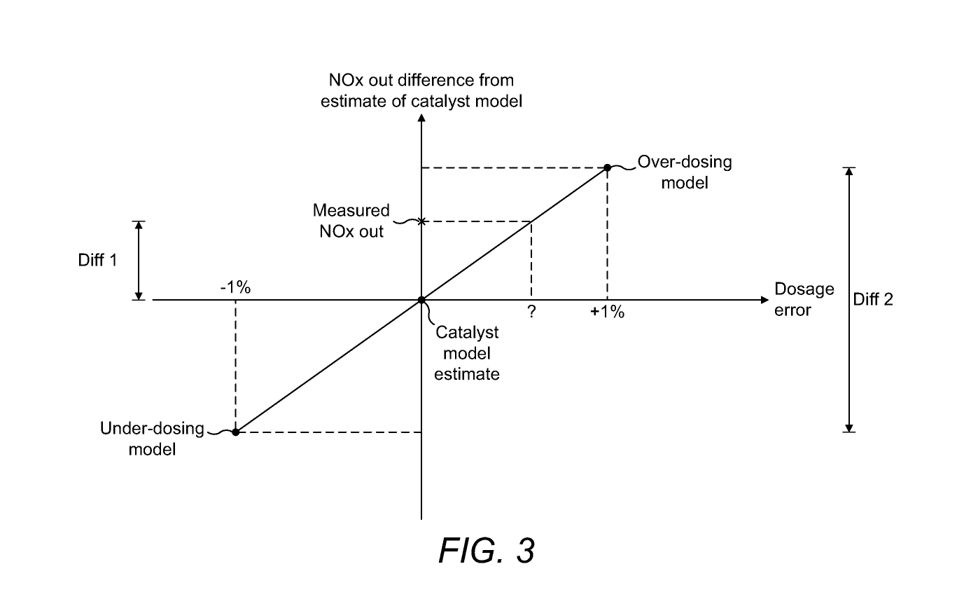

FIG. 3 shows an example of an expected NOx out generated by the catalyst model, and NOx out estimates generated by the over-dosing model and the under-dosing model, at a single point in time. In this example, the actual NOx out reading from downstream NOx sensor 48 is somewhere between the expected NOx out generated using the catalyst model and the estimated NOx out generated using the over-dosing model.

The difference between the NOx out estimate obtained using the over-dosing model and the NOx out estimate obtained using the under-dosing model is labelled diff2. The difference between the expected NOx out generated by the catalyst model and the NOx out measurement from the downstream NOx sensor 48 is labelled diff1.

The type of dosage error (i.e., over-dosing or under-dosing) indicated by the NOx out measurement shown in FIG. 3 is be found by cross-correlating the NOx readout difference (the difference between the expected NOx output level 37 and a measured NOx output level 38 from the downstream NOx sensor 48) with the NOx sensor sensitivity figure. The cross-correlation operation finds the product between the NOx readout difference and the NOx sensor sensitivity figure at the same point in time. The outcome from the cross-correlation shall be referred to herein as the mis-dosing indication figure, which indicates if the SCR device 20 is being under-dosed, correctly dosed or over-dosed.

The mis-dosing indication figure is a dimensionless number indicating the similarity between the NOx readout difference and the NOx sensor sensitivity figure. A positive mis-dosing indication figure may indicate that the SCR device 20 is being over-dosed, a negative mis-dosing indication figure may indicate that the SCR device 20 is being under-dosed and a mis-dosing indication figure of zero may indicate that the SCR device 20 is being correctly dosed.

The mis-dosing indication figure is not subject to the cross-sensitivity of the downstream NOx sensor 48 to ammonia. That is to say, the mis-dosing indication figure indicates what type of dosing error may be occurring with independence from the ammonia cross-sensitivity.

This is a consequence of the inherent non-linear nature of cross-correlation. Linear control approaches, for example those that consider only the difference between expected NOx out and measured NOx out, may not differentiate between an elevated NOx out reading caused by an increase in NOx out and an elevated reading caused by ammonia slip. In the present disclosure, however, the NOx sensor sensitivity figure enables the cross-correlation to interpret the difference between the actual NOx out reading 38 and the expected NOx out and indicate if under-dosing or over-dosing is causing the difference.

As a consequence, the mis-dosing indication figure determined by the error calculation unit 34 may be used in closed loop control in order to indicate what type of dosing error may be taking place. Closed loop feedback of this type might enable dosing levels applied by the injector 40 to be changed in order to correct dosing errors.

For example, the mis-dosing indication figure may be fed back to the dosing calculation unit 36 in order to adjust the current dosing level 39 to correct for any mis-dosing identified by the mis-dosing indication figure. The mis-dosing indication figure may also, or alternatively, be fed back to the estimator unit 32 in order to adjust the catalyst model.

The mis-dosing indication figure may be improved by transient events in the measured NOx output level 38 as a consequence of the cross-correlation operation.

Transient events may be caused, for example, by a sudden, short-lived increase in NOx output from the internal combustion engine 10, caused by a short, rapid increase in engine load, which may cause a transient spike in NOx output from the SCR device 20. This may be a consequence of the controller 30 being unable to instantaneously increase the amount of ammonia stored on the catalyst before the spike in NOx out from the internal combustion engine 10 has reached the catalyst.

The transient spike of NOx output from the SCR device 20 may be predicted to an extent by the catalyst model in the estimator unit 32, and therefore the expected NOx out 37 may include the transient spike and the NOx readout difference may remain steady. However, there may be a disagreement between the state of the SCR device 20 and the state of the catalyst model, in which case the NOx readout difference may also spike, which may reveal information about the differences between the catalyst model and the catalyst itself. The mis-dosing indication figure may pick up this information by virtue of the cross-correlation operation.

The mis-dosing indication figure may be calculated a plurality of times by taking multiple exhaust gas state 31 readings and readings from the downstream NOx sensor 48 and performing the above steps for each set of readings. For example, readings may be taken every second, or every 100 ms. The sensitivity estimate used to determine the mis-dosing indication figure may be determined once, either before running the control method or at the start of running the control method, or may be determined a number of times during run-time, for example at the same time as each NOx out and input exhaust gas state reading, or more or less frequently than those measurements.

The plurality of mis-dosing indication figures may be accumulated over time and the average of those accumulated figures found. As a consequence of accumulation and averaging, the influence of short term errors and noise may average out.

The accumulation of mis-dosing indication figures may take place for only a short period of time, for example two or three sample periods, or may last indefinitely, with the averaging function continually improving and refining the cross-correlation figure. The period over which the cross-correlation takes place may be at least one hour, after which time short term errors and noise may average out. However, significantly shorter time periods may still generate useful results.

By continually monitoring the mis-dosing indication figure over time, any sensor drift, changes in the dynamics of the catalyst, changes in the accuracy of the injector 40 and changes in any other factor affecting the accuracy of the catalyst model, may be picked up by the average mis-dosing indication figure. Consequently, the above explained closed-loop feedback of the mis-dosing indication figure to the estimator unit 32 and/or the dosing calculation unit 36 may be performed throughout the life of the SCR device 20.

If the mis-dosing indication figure is monitored over time, it may be filtered, for example, low pass filtered in order to remove high-frequency events, such as noise in sensor readings or singular events. By performing low pass filtering, long term, persistent causes of dosing error, such as sensor drift, may be represented in the mis-dosing indication figure, but short lived errors caused by noise and/or singular events may be removed, thus allowing the mis-dosing indication figure to converge gradually on a figure.

The mis-dosing indication figure may be accumulated and averaged over time using any one of a large number of techniques that would be well known to the person skilled in the art. For example, the mis-dosing indication figures may be stored in memory over a period of time and the mean mis-dosing indication figure determined using those stored figures.

Alternatively, an exponentially weighted mis-dosing indication figure may be determined by, for example, passing the mis-dosing indication figure through a low pass filter.

By using a low pass filter to generate an exponentially weighted average mis-dosing indication figure, less memory may be required and both low-pass filtering and averaging may be performed by a single process.

Furthermore, by determining the exponentially weighted average mis-dosing indication figure, more recent mis-dosing indication figures are given a greater importance than older figures. Thus, if the control method has been running for a long period of time, very old information, which might have been obtained when the SCR device 20 was operating under very different conditions, might effectively be discarded, and newer information, which might be more relevant to how the SCR device 20 is currently operating, might have more influence over the control of the SCR device 20.

There are a number of other techniques by which older information might be discarded, which will be well known to the skilled person. For example, if the average mis-dosing indication figure is determined from the mean of a number of stored mis-dosing indication figures, the mean might only be determined from a particular number of the most recent figures. For example, the 100 most recent figures stored in memory, and all older figures might be discarded.

It may be possible also to use a time delay in the estimator unit 32. It may take exhaust gases some time to pass through the SCR device 20 and, consequently, a volume of gas which is sensed by the sensors 42, 44 and 46 upstream of the SCR device 20 may take some time, for example, 2 seconds, to travel through the SCR device 20 and be sensed by the downstream NOx sensor 48. This time delay may be referred to as the ‘transport delay’.

By adding a time delay approximately equal to the transport delay of the SCR device 20 into the estimator unit 32, it may be possible for the estimator unit 32 to generate an expected NOx output level 37 which takes the transport delay into account. For example, a volume of gas which is sensed upstream of the SCR device 20 may experience a transport delay of 2 seconds. The estimator unit 32 may consider the readings from the upstream sensors and generate a NOx out estimate which it may expect to occur 2 seconds later. That NOx out estimate may then be sent to the error calculation unit 34 after the 2 second time delay so that the NOx out measurement from the downstream NOx sensor 48 may be directly compared with the delayed expected NOx out level. Alternatively, the error calculation unit 34 may include the time delay such that it stores the NOx out estimate from the estimator unit 32 for a period of time equal to the time delay, and then compares it to the measured NOx output level 38. A time delay may be used regardless of whether or not the mis-dosing indication figure is accumulated over time.

The scale of the mis-dosing indication figure may depend on many parameters, and so the magnitude of the figure by itself may not provide a useful indication of the degree of mis-dosing taking place.

In order to identify the magnitude of a dosing error which is taking place, the error calculation unit 34 might determine a dosing error figure e from the mis-dosing indication figure.

The dosing error figure e is a dimensional number which indicates not only if the SCR device 20 is being over or under dosed, but also the extent of the dosage error. The dosing error figure e might indicate the dosage error in a number of different units; for example, it might indicate the mis-dosing as volume of reductant (e.g., 10 mg over-dosing), as a rate of dosing of reductant (e.g., 5 mg/sec under-dosing), as a concentration of active ingredient within the reductant (e.g., 15 ppm overdosing) or a percentage of mis-dosing (e.g., 2% under-dosing). For example, a dosing error figure e of 0 might indicate correct dosing; a dosing error figure e of 0.005 might indicate 0.5% overdosing; a dosing error figure e of 0.01 might indicate 1% overdosing; a dosing error figure e of −0.005 might indicate 0.5% under-dosing; and a dosing error figure e of −0.01 might indicate 1% under-dosing.

The dosing error figure e may be calculated using a number of different techniques depending upon the desired form of dosing error figure e. For example, a percentage dosing error figure e may be determined by dividing the mis-dosing indication figure (or accumulated average mis-dosing indication figure) by the auto-correlation of the NOx sensor sensitivity figure.

The auto-correlation of the NOx sensor sensitivity figure may be the square of the NOx sensor sensitivity figure, and it may represent the expected mis-dosing indication figure at a notional mis-dosing condition.

If the dosing error figure e is determined, it may be fed into the dosing calculation unit 36 and/or the estimator unit 32 instead of the mis-dosing indication figure to perform closed-loop control of the current dosing level 39. By feeding back the dosing error figure e, rather than the mis-dosing indication figure, the type and magnitude of the dosing error, rather than just the type of dosing error, may be taken into account.

For example, the dosing calculation unit 36 may modify the dosing level that is determined by the feed forward controller on the basis of the dosing error figure e, such that the current dosing level 39 applied to the injector 40 is corrected to overcome the dosing error. In the case of a percentage dosing error figure e, the figure determined using the technique above may be added to 1 (such that a dosing error figure e=1 indicates perfect dosing, e=1.01 indicates 1% overdosing and e=0.995 indicate 0.5% under-dosing) and then the dosage level determined by feed forward control can be divided by the dosing error figure e. As a result, feed-back control may be achieved, which adjusts the level of dosing applied to the SCR device 20 so that ammonia slip and NOx output from the SCR device 20 may be reduced.

Additionally, or alternatively, the dosing error figure e may be used by the estimator unit 32 to adjust the catalyst model. Because the dosing error figure e is an indication of the level of mis-dosing caused by, for example, sensor inaccuracies and drift, inaccuracies in the injector 40 and changes in catalyst storage dynamics, adjusting the catalyst model on the basis of the dosing error figure e may result in the catalyst model itself incorporating, and compensating for, the causes of the mis-dosing. This again turns the dosing level feed forward control scheme into a feed back control scheme.

Various modifications of the method described above which fall within the scope of the present disclosure are contemplated.

For example, as will be readily apparent to the skilled person, a number of the steps which are performed by the controller 30 may be performed in a different order to that described above. This may lead to mathematically identical results, or it may lead to variations in results, which may still create a functional system.

One such example of this is obtaining the mis-dosing indication figure by performing cross-correlation first and then finding a difference value. In this example, the error calculation unit 34 cross-correlates the measured NOx output level 38 with the NOx sensor sensitivity figure and cross-correlates the expected NOx out 37 with the NOx sensor sensitivity figure and then obtains the mis-dosing indication figure by finding the difference between those two cross-correlation figures.

Furthermore, the filtering operation described above in respect of the accumulated mis-dosing indication figure may instead be formed at any stage of the method. For example, it may be performed on the measured NOx output level 38 and/or the expected NOx out 37, or it may be performed on the NOx readout difference, or on one or both of the cross-correlation figures described in the above paragraph.

Rather than considering the expected and measured NOx output from the SCR device 20, different aspects of the expected and measured exhaust gas output state may alternatively be considered, for example amount of ammonia.

FIGS. 1 and 2 show a controller 30 in accordance with an aspect of the present disclosure.

The controller 30 may be configured to carry out the method steps described in the present disclosure.

The controller 30 may have a number of inputs and outputs which may be used by the estimator unit 32, the error calculation unit 34 and the dosing calculation unit 36 in order to perform the above described method steps. For example, the inputs might include, but are not limited to: the measured NOx output level 38 and the measured state 31 of the exhaust gas input to the SCR device 20, which may include the NOx in level, the exhaust gas temperature and the mass flow rate of the exhaust gas. The controller 30 may also have a number of outputs, including, but not exclusive to, the dosing level control signal 39.

The controller 30 may be implemented in an engine control unit, for example the Caterpillar® A4:E4 or A5:E2, or as a standalone control unit.

FIG. 1 also shows an SCR system comprising an SCR device 20 and the controller 30, which is arranged to determine if the SCR device 20 is being mis-dosed. Furthermore, FIG. 1 also shows an engine unit comprising an internal combustion engine 10 and the SCR system.

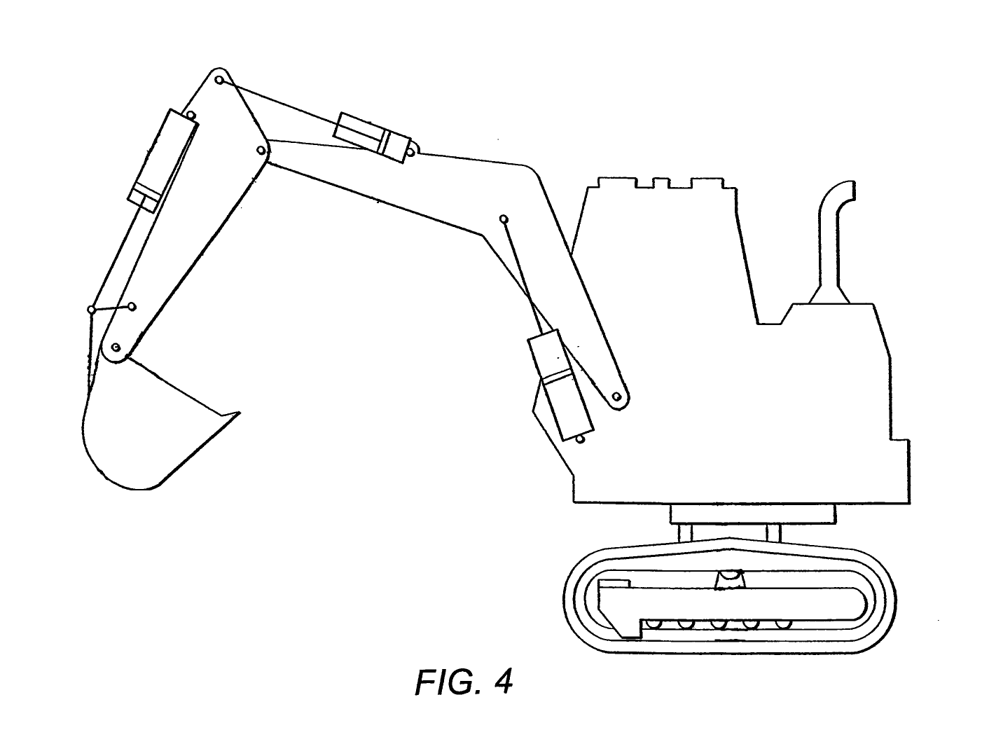

FIG. 4 shows a vehicle within which the engine unit shown in FIG. 1 could be used.

### INDUSTRIAL APPLICABILITY

The present disclosure finds application in determining if an SCR device is being mis-dosed with reductant. A mis-dosing indication figure is identified using a measured exhaust gas output state, an expected exhaust gas output state and a NOx sensor sensitivity figure, and by performing cross-correlation. As a consequence of the non-linear nature of the cross-correlation, ambiguity of the NOx output reading caused by the NOx sensor's cross-sensitivity with NOx and ammonia may be resolved such that it may be determined more reliably if the NOx output sensor is measuring NOx or ammonia and therefore indicate more accurately if the SCR device is being under-dosed or over-dosed. Furthermore, and in contrast to linear techniques, the non-linear nature of the cross-correlation also results in an improvement of the mis-dosing indication figure when transient events in the NOx out measurement occur.

This more reliable mis-dosing indication figure may be used to correct dosing errors and therefore minimise the emission of NOx or ammonia slip from the SCR device. For example, the mis-dosing indication figure can be used in closed loop control of reductant dosing of the SCR device so that the dosing levels applied to the SCR device may be changed to correct dosing errors. Additionally, or alternatively, the catalyst model may be adjusted on the basis of any mis-dosing identified by the mis-dosing indication figure so that the catalyst model may more accurately reflect the actual SCR device and therefore better estimate the catalyst storage state, which might enable a more suitable dosing level to be set, thereby reducing NOx and ammonia emissions.

A mis-dosing indication figure may be determined periodically over time and an average mis-dosing indication figure obtained, which may improve the reliability of the mis-dosing indication figure by averaging out the influence of short term errors and noise and therefore be useful in identifying long term causes of mis-dosing, such as sensor drift, changes in the dynamics of the catalyst and changes in the accuracy of the reductant injector. The mis-dosing figure that is accumulated over time may also undergo filtering to remove high-frequency events caused by noise and/or singular events, thereby even further improving the reliability of the mis-dosing indication figure.

The mis-dosing figure may be a dimensionless number that merely indicates if the SCR device is being under-dosed or over-dosed. However, it may be made into a dimensional number (dosing error figure) using any one of the techniques described in the above disclosure, such that it indicates not only if over-dosing or under-dosing is taking place, but also the degree of over-dosing or under-dosing that is taking place. This may improve the quality of close-loop feed back control of the dosing level and catalyst model since the degree of change required to the dosing level and catalyst model may be known from the magnitude of the dimensional dosing error figure.

A time delay may be introduced to the control system in order to compensate for the transport delay of the SCR system and thereby improve the accuracy of the mis-dosing indication figure.

1. A method for determining if a selective catalytic reduction (SCR) device that is dosed with a reductant is being mis-dosed, the method comprising the steps of:
determining a first cross-correlation figure by cross-correlating a measured exhaust gas output state with a NOx sensor sensitivity figure, wherein the NOx sensor sensitivity figure is an indication of how sensitive the measured exhaust gas output state is to dosing errors;
determining a second cross-correlation figure by cross-correlating an expected exhaust gas output state from the SCR device with the NOx sensor sensitivity figure; and
determining a mis-dosing indication figure which indicates if the SCR device is being under-dosed, correctly dosed or over-dosed from the difference between the first cross-correlation figure and the second cross-correlation figure.

2. A method for determining if a selective catalytic reduction (SCR) device that is dosed with a reductant is being mis-dosed, the method comprising the steps of:
determining a NOx readout difference figure from the difference between an expected exhaust gas output state from the SCR device and a measured exhaust gas output state from the SCR device; and
determining a mis-dosing indication figure which indicates if the SCR device is being under-dosed, correctly dosed or over-dosed by cross-correlating the NOx readout difference with a NOx sensor sensitivity figure, wherein the NOx sensor sensitivity figure is an indication of how sensitive the measured exhaust gas output state is to dosing errors.

3. The method of claim 1, wherein a dosing error figure is determined by dividing the mis-dosing indication figure by an auto-correlation of the expected exhaust gas output state.

4. The method of claim 3, wherein the NOx sensor sensitivity figure is determined by differentiating the expected exhaust gas output state by the dosing error figure.

5. The method of claim 1, wherein the NOx sensor sensitivity figure is determined by dividing the difference between the expected exhaust gas output state and the measured exhaust gas output state by the difference between the expected exhaust gas output state and an estimated exhaust gas output state determined by a mis-dosing model which estimates the exhaust gas output state based upon a notional under-dosing or over-dosing condition.

6. The method of claim 1, wherein the NOx sensor sensitivity figure is determined by dividing the difference between the expected exhaust gas output state and the measured exhaust gas output state by the difference between an exhaust gas output state estimated by a notional over-dosing model and an exhaust gas output state estimated by a notional under-dosing model.

7. The method of claim 1, wherein the mis-dosing indication figure is determined a plurality of times over a period of time and the average of the plurality of mis-dosing indication figures is found.

8. The method of claim 7, wherein the plurality of mis-dosing indication figures is low-pass filtered in order to remove high-frequency noise.

9. The method of claim 1, wherein the expected exhaust gas output state from the SCR device is determined from at least one of a measured state of the exhaust gas input to the SCR device, the level of reductant dosing applied to the SCR device and an estimate, or measurement, of the catalyst temperature.

10. The method of claim 1, wherein the measured state of the exhaust gas input to the SCR device comprises at least one of the amount of NOx in the exhaust gas, the temperature of the exhaust gas and the mass flow rate of the exhaust gas.

11. A controller to determine if a selective catalytic reduction (SCR) device that is dosed with a reductant is being mis-dosed, the controller being configured to perform the method of claim 1.

12. A controller to determine if a selective catalytic reduction (SCR) device that is dosed with a reductant is being mis-dosed, the controller being configured to perform the method of claim 2.

13. An SCR system comprising:
an SCR device that is dosed with a reductant, and
the controller defined in claim 11, the controller being arranged to determine if the SCR device is being mis-dosed.

14. An internal combustion engine comprising the SCR system defined in claim 13.

15. A vehicle comprising the internal combustion engine defined in claim 14.

16. An SCR system comprising:
an SCR device that is dosed with a reductant, and
the controller defined in claim 12, the controller being arranged to determine if the SCR device is being mis-dosed.

17. The method of claim 2, wherein a dosing error figure is determined by dividing the mis-dosing indication figure by an auto-correlation of the expected exhaust gas output state.

18. The method of claim 17, wherein the NOx sensor sensitivity figure is determined by differentiating the expected exhaust gas output state by the dosing error figure.

19. The method of claim 2, wherein the NOx sensor sensitivity figure is determined by dividing the difference between the expected exhaust gas output state and the measured exhaust gas output state by the difference between the expected exhaust gas output state and an estimated exhaust gas output state determined by a mis-dosing model which estimates the exhaust gas output state based upon a notional under-dosing or over-dosing condition.

20. The method of claim 2, wherein the NOx sensor sensitivity figure is determined by dividing the difference between the expected exhaust gas output state and the measured exhaust gas output state by the difference between an exhaust gas output state estimated by a notional over-dosing model and an exhaust gas output state estimated by a notional under-dosing model.
